(19) United States
(12) Patent Application Publication
(10) Pub. No.: US 2025/0346521 A1
(43) Pub. Date: Nov. 13, 2025

(54) SIMPLIFIED ENERGY-SAVING FURNACES FOR HEAT TREATMENTS OF GLASS CONTAINERS

(71) Applicant: Euromatic S.r.l., Treviglio (BG) (IT)

(72) Inventor: Giorgio GUSMINI, Treviglio (BG) (IT)

(21) Appl. No.: 18/867,394

(22) PCT Filed: May 15, 2023
(86) PCT No.: PCT/IB2023/054983

§ 371 Date: Nov. 19, 2024

(30) Foreign Application Priority Data
May 20, 2022 (IT) 102022000010508

(51) Int. Cl. C03B 35/06; B65G 19/02; F27B 9/24

(52) U.S. Cl. CPC C03B 35/062; B65G 19/02; F27B 9/24

(57) ABSTRACT

A furnace for heat treatment of glass containers may include: a thermally insulated structure; and a conveyor unit. The conveyor unit may include pallets configured to feed the glass containers to a loading area, heating area, cooling area, and unloading area of the furnace. The conveyor unit may define a pallet flow path along an upper conveying branch, lowering branch, lower return branch, and raising branch. Shaped rods, extending from opposite sides of the pallets, may connect to one or more drive units external to the thermally insulated structure. The shaped rods may pass through slits in the thermally insulated structure. At least one of the one or more drive units may include a drive element selectively connected to the pallets along the pallet flow path. The raising branch may include an ascent elevator and the lowering branch may include a descent elevator at opposite ends of the heating area.

The present invention refers to a simplified energy-saving furnace for heat treatment of glass containers.

Various types of furnace are known for the heat treatment of glass containers, such as vials, bottles, cartridges, syringes, etc.

The document EP960863B1 belonging to the applicant illustrates a known furnace for the continuous heat treatment of glass containers. Said furnace comprises a structure containing a conveyor which is designed to receive containers and which is made to advance through a hot zone and a ventilated zone. In said furnace, the conveyor comprises a pair of chains which are located on opposite sides of the structure and wound in an endless loop onto toothed end pulleys so as to define an upper conveying section and a lower return section. The links of each of the two chains bear a plurality of flat brackets, which project in a cantilevered manner and are directed inwards towards the opposite chain. Furthermore, cross-pieces are mounted on the brackets provided with a plurality of supports for resting at least a portion of the cited glass containers. In said conveyor it is further known that the cross-pieces and the brackets are translatable with respect to one another.

A furnace of this kind functions well, but the presence of the chains, brackets and supports inside the furnace generate expansions and distortions during operation. Although these expansions and distortions are partial due to the specific structure of the furnace, they nevertheless highlight some limits.

In fact, the chains undergo expansions which in the long term compromise their correct feed.

The presence of a large metal mass between chains, cross-pieces, supports and transmission elements absorbs heat, subtracting it from correct operation of the furnace. The absorption of heat also increases consumption of the furnace and wastes energy otherwise intended for heating the furnace and the glass containers.

The arrangement of chains, cross-pieces and supports inside the furnace causes problems with intervention and maintenance in the event of a failure and consequent replacement of parts.

The general object of the present invention is to provide a furnace for heat treatment of glass containers able to solve the above-mentioned drawbacks of the known art in an extremely simple, inexpensive and particularly functional manner.

A further object of the present invention is to provide a simplified and energy-saving furnace for heat treatment of glass containers which is simple in terms of construction and assembly and easy to service and maintain.

A further object of the present invention is to provide a furnace for the heat treatment of glass containers in which energy consumption is optimized, allowing considerable saving and less transmission of heat to the outside. The above-mentioned objects are achieved by a simplified energy-saving furnace for heat treatment of glass containers produced according to the independent claim 1 and the following sub-claims.

The structural and functional characteristics of the present invention and its advantages over the known art will become even clearer and more evident from an examination of the following description, referring to the attached schematic drawings, which show an embodiment example of the invention.

In the drawings:

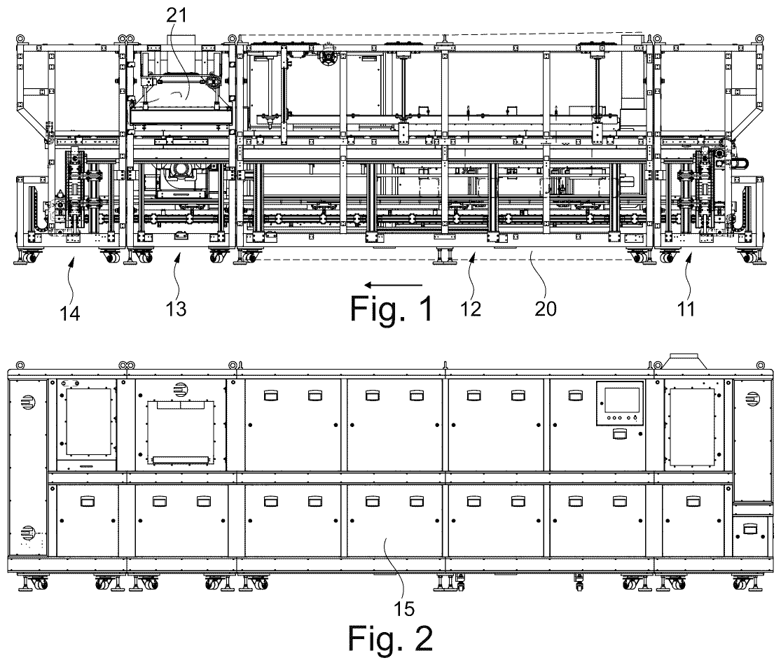

FIGS. 1 and 2 show a lateral elevation view of the furnace of the present invention in its structural parts;

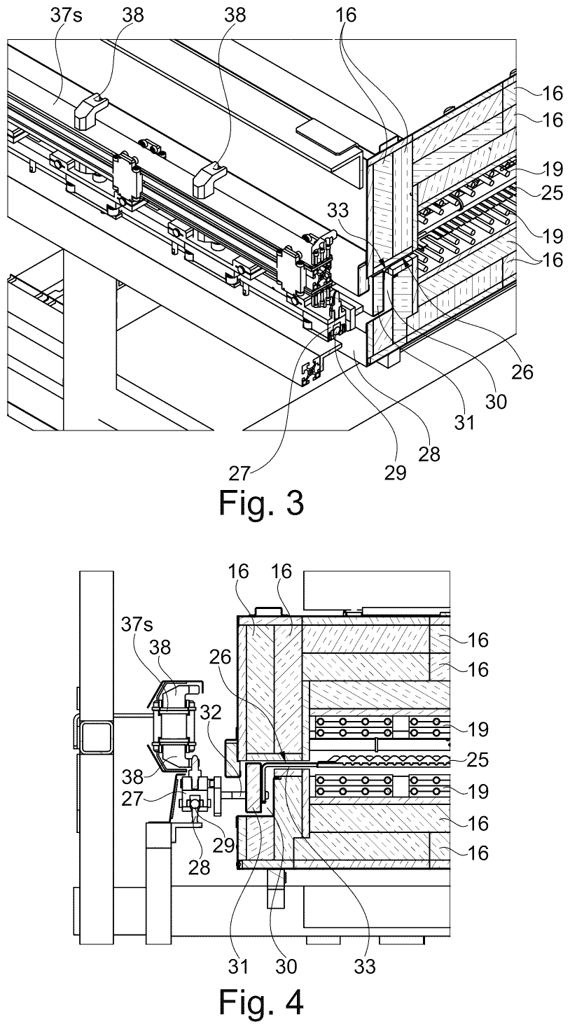

FIGS. 3 and 4 show sections of the furnace relative to motion transmission in an external cut-away perspective view and in a cross-section view;

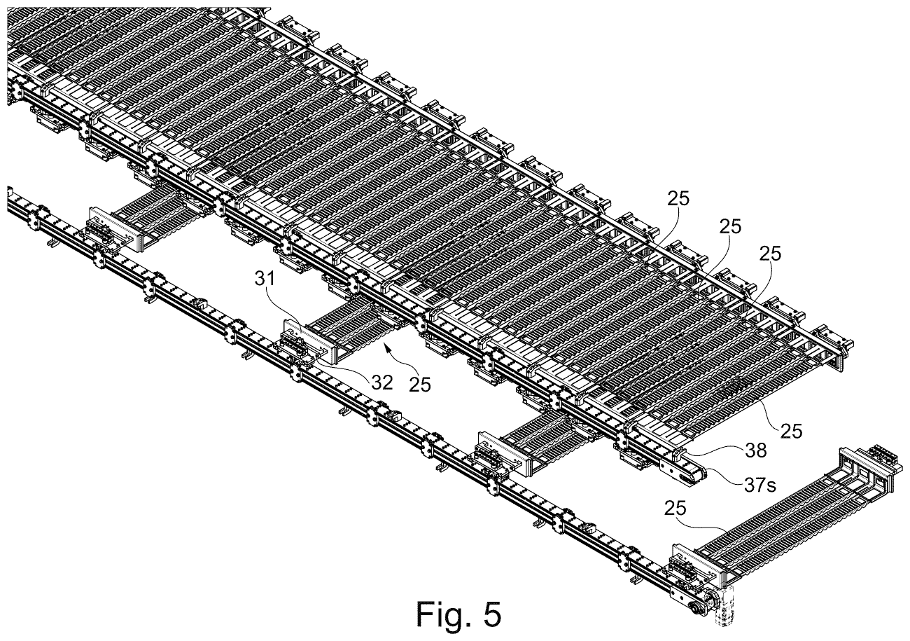

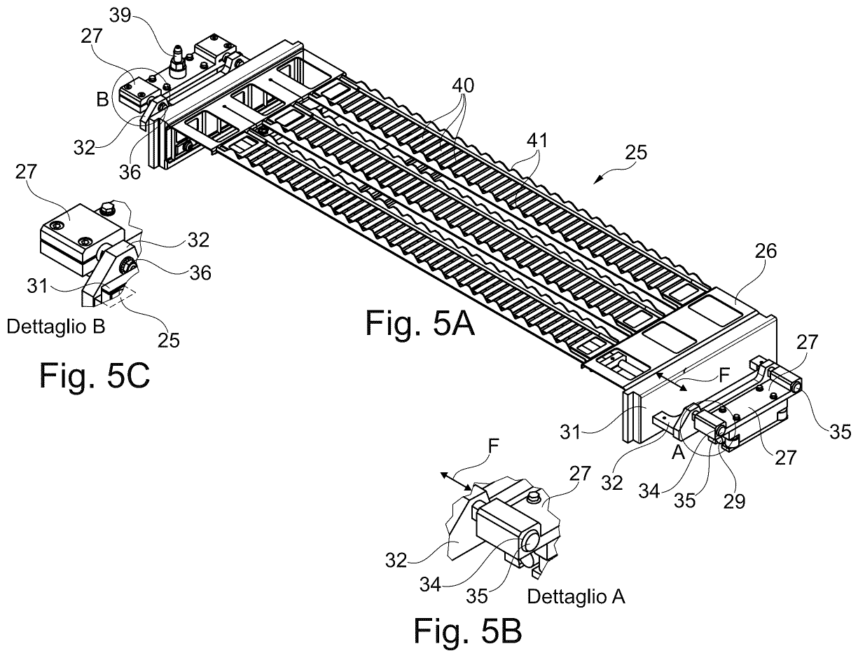

FIG. 5 shows a schematized view in perspective of the pallet conveyor unit in the furnace of the present invention;

FIGS. 5A, 5B and 5C show in perspective view a pallet and its end parts enlarged;

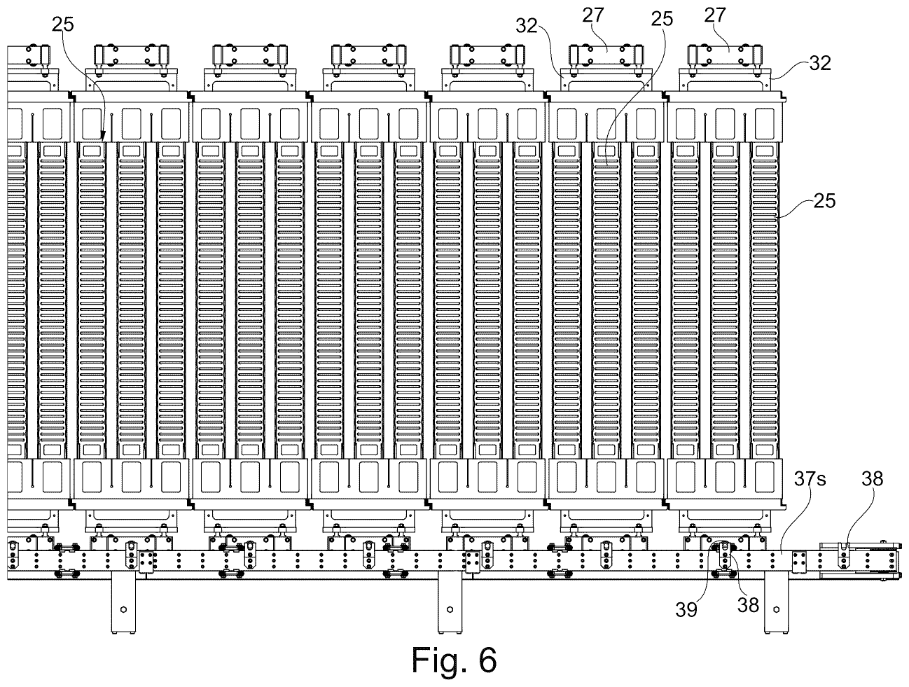

FIG. 6 is a plan view from above of the conveyor unit and component pallets;

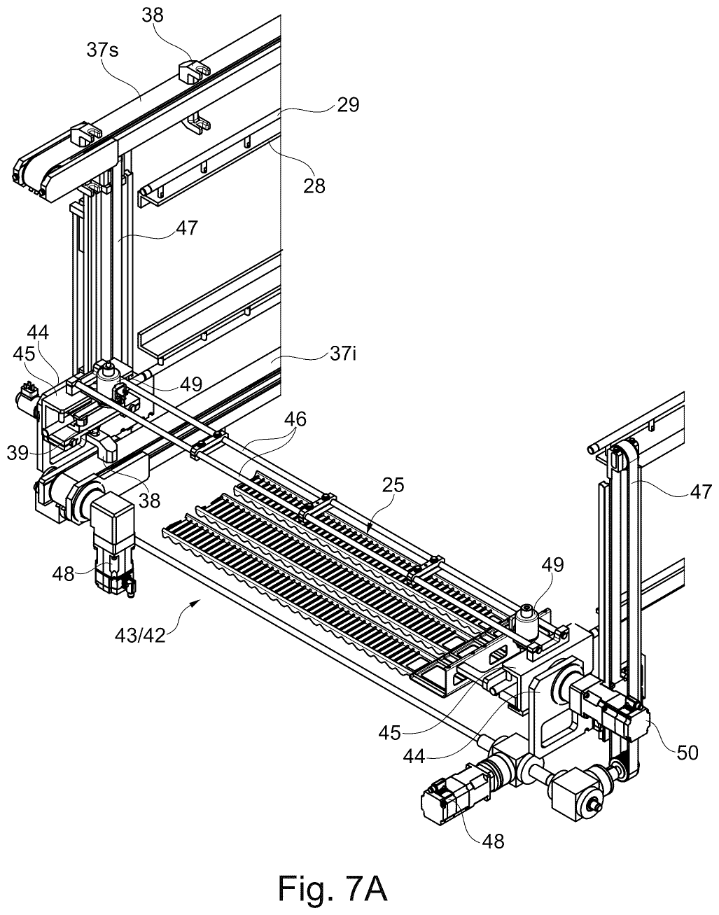

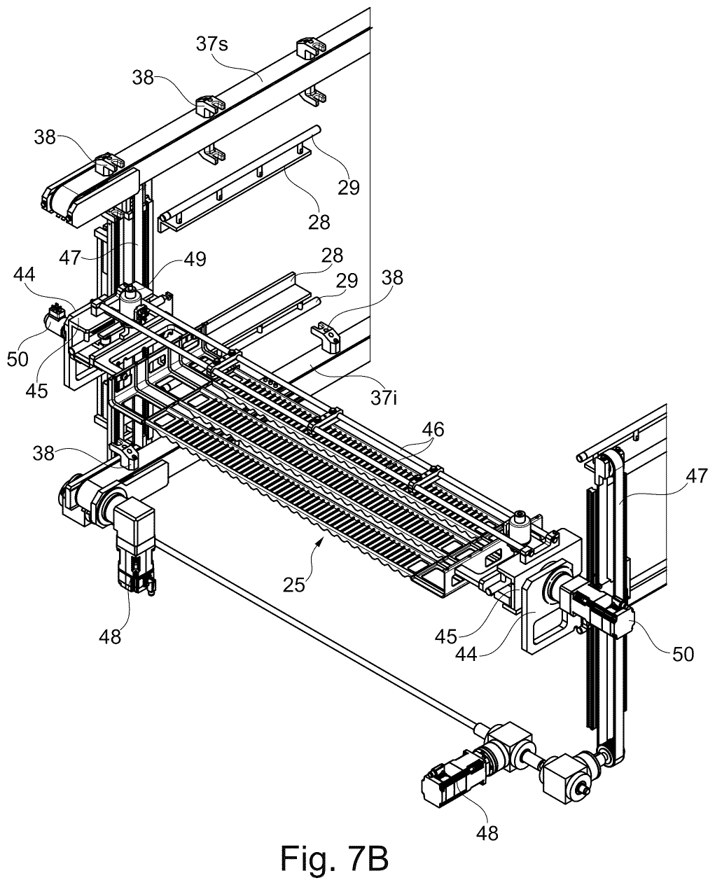

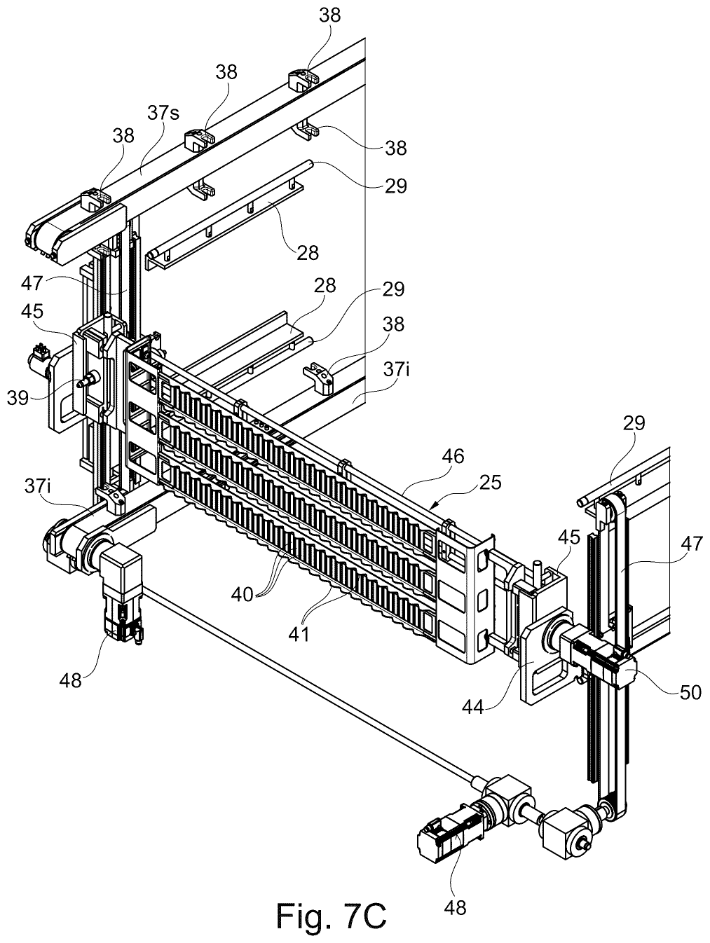

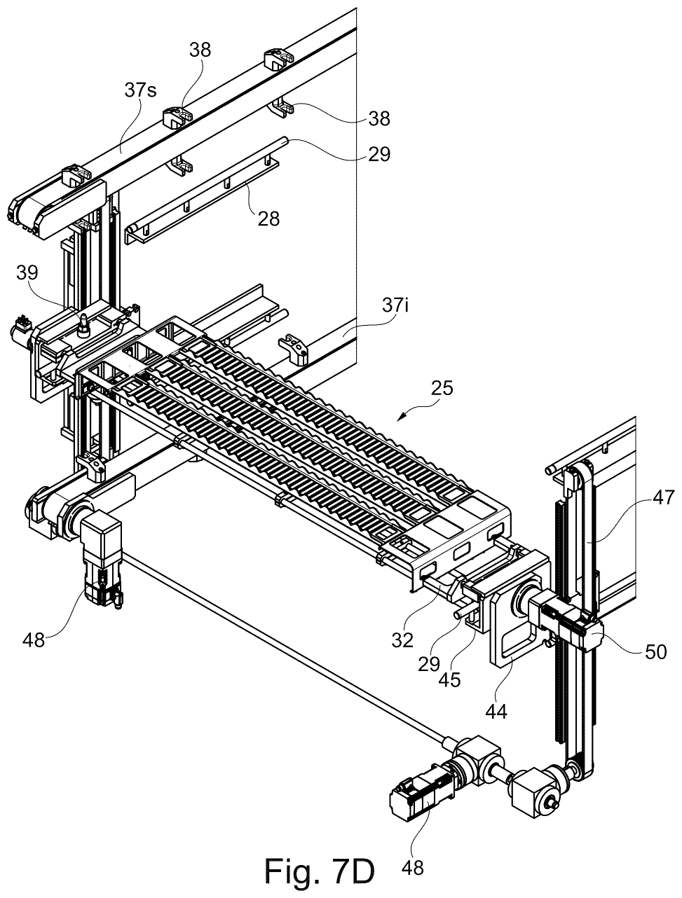

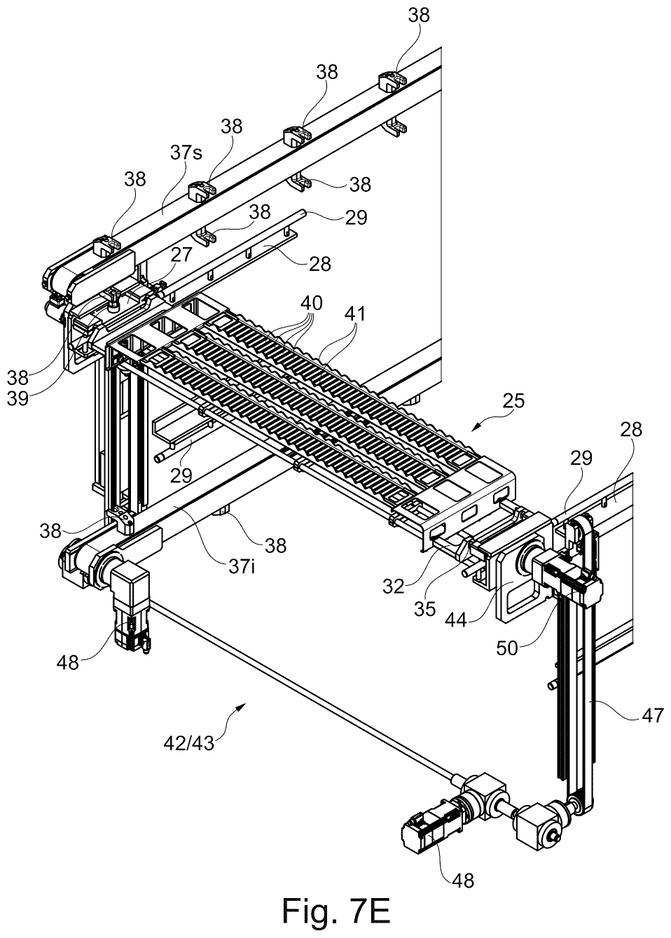

FIGS. 7A to 7E are lateral perspective views of the elevator unit that conveys the furnace pallets from the upper inlet and furnace feed-in section to the lower section for return to the furnace inlet and vice versa;

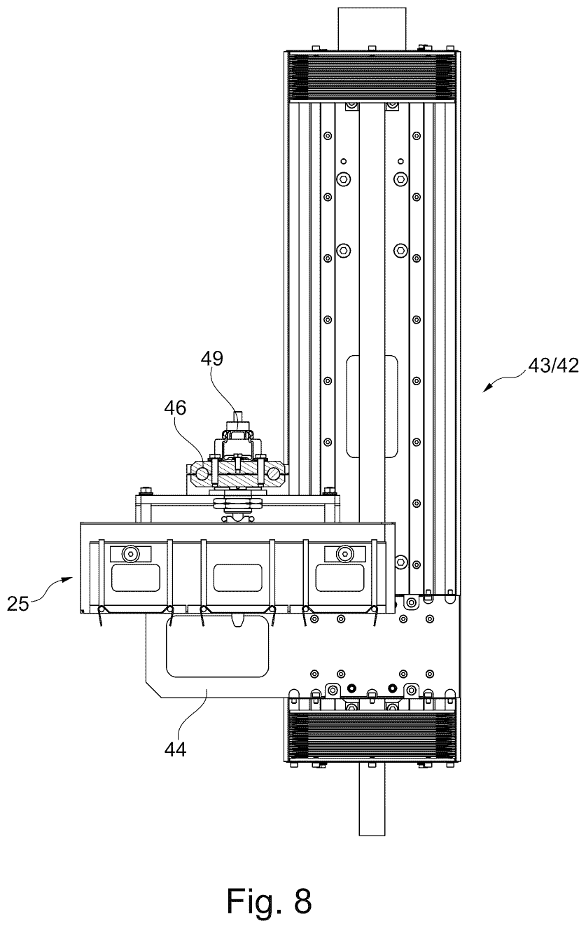

FIG. 8 is a lateral elevation view of the elevator unit shown in FIGS. 6A to 6E in an operating position.

In the following description, for illustration of the figures, identical reference numbers are used to indicate construction elements with the same function. Furthermore, for clarity of illustration, some numerical references may not have been repeated in all the figures.

Indications such as “vertical” and “horizontal”, “upper” and “lower” (in the absence of other indications) shall be read with reference to the assembly (or operating) conditions and referring to the normal terminology currently in use, where “vertical” indicates a direction substantially parallel to that of the gravitational force vector “g” and horizontal a direction perpendicular to it.

With reference to the figures, provided by way of non-limiting example, an embodiment is shown of a furnace for heat treatment of glass containers, such as vials, bottles, cartridges, syringes, etc. with optimized operation according to the present invention.

Said furnace comprises a structure in which an inlet or loading area 11, a heated area 12, a cooling area 13 and an outlet or unloading area 14 can be identified.

In the particular embodiment shown, said structure is of modular type and comprises four modules in the four areas previously indicated, connectable to one another both mechanically and electrically. The structure is entirely metallic and insulating elements are secured to it in the heated area for insulating the furnace walls.

It should be noted that, advantageously, the inlet or loading area 11 and the outlet or unloading area 14 are perfectly symmetrical and specular, allowing simplifications in manufacture of the entire furnace and savings in the quantity of parts required for the construction and assembly thereof. In FIG. 1 it can be seen that in the entire furnace said modules 11, 14 are arranged inverted with respect to each other.

The heated area 12 has insulated walls 15 that form a heating tunnel. Said heating tunnel can be made by means of panels of insulating material 16 which cooperate with sealed air chambers 17 and/or sectioning arrangements 18 that create thermal bridges, allowing considerable energy saving and minimum heat dispersion.

In this heated area 12 said heating is provided by heater units 19 such as electric radiant heaters, graphene IR radiant heaters, etc.

Around the heated area 12 a sealed chamber 20 can be provided that allows recovery and re-use of the hot air present in the heated area around and at the outlet of the furnace to pre-heat the glass products to be treated as they enter the furnace and the relative pallets that carry them, which will be seen below.

The cooling area 13 is obtained by means of one or more modular, independent, low consumption fans 21, readily available on the market, for example installed at the bottom of the structure.

In this innovative structure an innovative conveying unit is included in which the moving parts, also innovative, are located outside the furnace structure cited above.

Said conveying unit comprises a series of transverse pallets 25, arranged one after the other and bearing support elements for the glass products to be treated (FIGS. 5 and 5A). Opposite ends of the pallets extend into upturned L-shaped wings 26 that carry U-shaped support and sliding carriages 27 facing downwards which are arranged astride a sliding guide 28, for example composed of a drawn round bar 29, and are thus controlled to translate outside the furnace.

More precisely, the upturned L-shaped wings 26 are inserted in and pass through longitudinal slits 33 of walls of the heated area 12 until they are arranged in an enlarged seat 30 of the walls, following a labyrinth path that reduces the outflow of heat from the furnace.

Preferably the base part, elongated downwards, of the L-shaped wings 26 carries a section of insulating wall 31 which is thus integral with the pallet 25. Shaped rods 32 bearing the support carriages 27 extend from the upturned L-shaped wings 26.

The pallets 25 are supported with respect to the carriages 27 as shown in FIGS. 5A, 5B and 5C so that the transmission unit is not affected by the thermal expansions acting on each pallet. In fact, the pallet 25 on one side is fixed to a carriage 27 by means of a bolt 36 (FIG. 5C) while on the opposite side (FIG. 5B) it can slide and translate with respect to the carriage 27. The support carriage 27 is provided at the top with through holes 34 in which pins 35 are inserted free to slide that extend from the shaped rod 32 constrained to the respective upturned L-shaped wing 26. In this way the pallet is able to expand and translate with respect to the sliding guide 28 according to the arrow F without affecting said guide system 27, 28 and 29.

The support carriages 27 have the shape of an upturned C, are non-magnetic, are arranged astride the sliding guide 28 or the drawn round bar 29 and slide thereon. Said sliding guide is constrained with respect to the outside of the furnace. For example the magnetic drawn round bar 29 is constrained to the external structure of the furnace or directly to the floor so that it is not affected by the expansions produced by the furnace.

The path of the pallets is a quadrilateral or rectangular path that has a feed section at the top of the furnace, a descent section at one end of the furnace, a return section at the bottom (identical to the feed section at the top, but inverse) and an ascent section at the other end of the furnace. The pallets are driven both in the upper feed section and in the lower return section of the path by a pair of control belts 37s, 37i external to the furnace moved by a servomotor 48. Each control belt 37s, 37i is wound in an endless loop laterally and externally to the furnace along the upper feed section and lower return section of the path.

FIGS. 3, 4, 5 and 7A-E show this arrangement. More precisely, the control belt 37s, 37i for the translation movement of the pallets 25 is provided at a regular distance thereon with U-shaped drive elements 38 that receive pin extensions 39 integral with the support carriages 27 of each pallet 25 and which extend on the opposite side with respect to the sliding guide 28.

Alternatively, as a control for translation of the pallets 25, upper and lower chains can be used, in a simplified form with respect to the control belts 37s, 37i; said chains are constrained to the shaped rods or to the support carriages 27 in a similar way to the one described.

The chains can engage on support gear wheels arranged along the path and can be driven by driving and driven gear wheels located at the ends of the path in the furnace.

Each pallet 25 has a reverse C-shaped configuration that extends slightly less than the distance of the inner part between the insulated walls of the furnace. It presents as a sheet provided with a plurality of lightening notches 40 and transverse support elements 41 in the form of indentations for the glass products to be treated. Note that said glass products or containers are arranged longitudinally with respect to the furnace on the pallets differently from the pallets themselves 25 which are arranged crosswise to the furnace. Said glass containers are inclined and rest on one end.

Said pallets 25 can be replaced so that they can carry glass products of different type and size.

As said previously, the pallets 25 move inside the furnace along a quadrilateral or rectangular path which has a feed section within the furnace, a descent section at one end of the furnace, a return section and an ascent section at the other end of the furnace.

The above description both for the movement and sliding of the pallets and for the conveying unit in general in the feed section must be repeated and specular for the return section. This is due to the fact that, as mentioned, the movement of the pallets follows a linear path during their passage inside the furnace which is followed by a descent section of the pallet with upturning of the pallets and associated parts such as the shaped rods and the support carriages. Then in the return section towards the furnace inlet the upturned pallets translate on upturned guides until they reach the ascent section in which the pallets are upturned once again, returning to the initial furnace inlet position, likewise the guides which return to their initial arrangement to allow correct introduction into the furnace.

In the descent and ascent sections, descent 42 and ascent 43 elevators are arranged that receive the support carriages 27 of the pallets 25.

For example FIG. 7A shows the release of a pallet 25 coming from the lower return section which is loaded on an ascent elevator 43 that will re-position it on the upper furnace inlet section.

The upturned pallet 25 is conveyed forward towards the elevator 43 driven by the control belt 37i, the pin extensions 39 of which are engaged in respective drive elements 38.

The ascent elevator 43 has at opposite ends thereof, crosswise to the furnace, a pair of carriages 44 that receive the single pallet 25 within opposite C-shaped supports 45 (FIG. 7A).

Said opposite C-shaped supports 45 are arranged on board the cited carriages 44 and are connected to each other by tie rods 46 crosswise to the furnace which make them integral with each other. The carriages 44 are moved upwards and downwards by further control belts 47, arranged vertically. The control belts 47 are arranged in an endless loop and are controlled by a servomotor 48, identical to the previous one, by means of a transmission.

A locking device 49, on board the carriages 44, locks the pallet 25 on the supports 45 during the movement of the carriages 44 up, down and in rotation (FIG. 7B).

A further servomotor 50, carried by at least one of the carriages 44, rotates the supports 45 that carry the pallet 25 locked by the locking device 49 with respect to the carriages 44 (FIG. 7C). Said rotation determines a consequent rotation of the pallet by 180° arranging it ready to receive the glass containers to be treated (FIG. 7D).

Lastly, the pallet 25 is freed from the locking device 49, on board the carriages 48, and released in order to be engaged and driven by the extensions 39 in the U-shaped drive elements 38 that receive them (FIG. 7E).

For example, in this position of the pallet, the glass containers to be treated are placed on the pallet by a suitable manipulator or robot, not shown, external to the furnace.

Identical movements are carried out in the descent elevator 42 positioned at the end of the heated section of the hot area.

During the descent and ascent sections it has been seen that the pallets are rotated 180°, overturning and being automatically cleaned.

Obviously the arrangement of the transmission of motion of the pallets external to the furnace and the sliding unit, also external, avoid all problems connected with expansions due to the temperatures and allow correct operation of the furnace regardless of the temperatures.

The magnetic levitation or chain sliding unit is provided naturally on both the longitudinal sides of the extension of the furnace.

The magnetic levitation transmission is particularly interesting as it compensates for any misalignments, has very low maintenance and practically no friction with low consumption of materials.

Positioning of the transmission externally to the body of the furnace allows rapid interventions as required, without disassembly of the furnace and reduction of the masses that heat up, resulting in energy saving.

The object mentioned in the preamble to the description is therefore achieved.

The protective scope of the present invention is defined by the attached claims.

1. A simplified energy-saving furnace for heat treatments of glass containers, the furnace comprising:
a structure thermally insulated from an outside which is essentially crossed by a conveyor unit configured to convey the glass containers;
wherein the conveyor unit comprises pallets configured to receive the glass containers to be treated and feed them forward in sequence to a loading area of the furnace, a heating area of the furnace, a cooling area of the furnace, and an unloading area of the furnace,
wherein the conveyor unit extends along a quadrilateral path to identify an upper conveying branch and a lower return branch, and raising and lowering branches for raising and lowering the pallets between the upper conveying branch and the lower return branch,
wherein the pallets are arranged crosswise to a feed direction of the conveyor unit, one after the other, and opposite ends of the pallets extend in shaped rods connected to a drive unit external to the thermally insulated structure, wherein the shaped rods pass through labyrinth slits in the thermally insulated structure,
wherein the drive unit comprises at least one drive element wound in an endless loop provided with a first servomotor selectively connected to the pallets one by one along the upper conveying branch and the lower return branch, and
wherein a descent elevator and an ascent elevator are provided at respective descent and ascent sections of a flow path of the pallets at opposite ends of the heating area.

2. The furnace of claim 1, wherein the shaped rods comprise upturned L-shaped wings which extend from both sides of the pallets and carry toward outside U-shaped support carriages facing downward which are on sliding guides on opposite sides external to the thermally insulated structure,
wherein the support carriages are controlled to translate, and
wherein the upturned L-shaped wings are inserted in and pass through longitudinal slits of walls of the thermally insulated structure of the heating area.

3. The furnace of claim 2, wherein one end of the upturned L-shaped wings that extends from the pallets is in an enlarged seat of the walls external to the thermally insulated structure providing a labyrinth path that reduces outflow of heat from the furnace.

4. The furnace of claim 12, wherein the sliding guides external to the thermally insulated structure comprise magnetic levitation guides on opposite sides with respect to the thermally insulated structure and each comprising on one side the support carriages and on the other side the sliding guides.

5. The furnace of claim 2, wherein the support carriages are non-magnetic and slide on the sliding guides made of a magnetic drawn round bar.

6. The furnace of claim 2, wherein the drive unit external to the thermally insulated structure consists of belts on opposite sides with respect to the thermally insulated structure, provided with U-shaped drive elements that receive pin extensions integral with the support carriages of each of the pallets.

7. The furnace of claim 2, wherein the drive unit external to the thermally insulated structure consists of chain transmissions, on opposite sides with respect to the thermally insulated structure, constrained to the support carriages.

8. The furnace of claim 2, wherein the pallets on one side are fixed to one of the support carriages, while on the opposite side the pallets can slide and translate with respect to the support carriages in a crosswise direction to the furnace.

9. The furnace of claim 6, wherein the pallets on one side are fixed to one of the support carriages using at least one bolt, while on the opposite side the pallets can slide and translate with respect to the support carriages which are provided at a top with through holes in which pin extensions are inserted free to slide and which extend from the shaped rods of the pallets.

10. The furnace of claim 1, wherein the descent and ascent elevators are provided with pairs of support carriages that receive a single one of the pallets within opposite C-shaped supports, and
wherein the opposite C-shaped supports are connected to each other by tie rods transverse to the furnace which make the opposite C-shaped supports integral with each other.

11. The furnace of claim 10, wherein the support carriages of the descent and ascent elevators are moved up and down by further control belts arranged vertically in an endless loop, and are controlled by a second servomotor using a transmission.

12. The furnace of claim 10, wherein a locking device is provided, on board the support carriages, that locks the pallets on the C-shaped supports during movement of the support carriages up, down, and in rotation.

13. The furnace of claim 10, wherein a third servomotor is carried by at least one of the support carriages and rotates the opposite C-shaped supports that carry the pallets by an angle of 180°.

14. The furnace of claim 1, wherein the loading area of the furnace, the heating area of the furnace, the cooling area of the furnace, and the unloading area of the furnace are modular and connectable to one another, both mechanically and electrically.

15. The furnace of claim 2, wherein each of the pallets has an upturned C-shaped configuration that extends slightly less than a distance of an inner part between the walls of the thermally insulated structure, and
wherein the pallets present as a sheet provided with a plurality of lightening notches and provided at a top with transverse support elements in a form of indentations for resting one end of the glass containers to be treated.

16. The furnace of claim 1, wherein the loading area of the furnace, the heating area of the furnace, the cooling area of the furnace, and the unloading area of the furnace are modular.

17. A furnace for heat treatments of glass containers, the furnace comprising:
a structure thermally insulated from an outside environment;
wherein the thermally insulated structure comprises a conveyor unit configured to convey the glass containers,
wherein the conveyor unit comprises pallets configured to receive the glass containers and to feed the glass containers forward in sequence to a loading area of the furnace, a heating area of the furnace, a cooling area of the furnace, and an unloading area of the furnace,
wherein the conveyor unit extends along a path to define an upper conveying branch, a lower return branch, a raising branch between the lower return branch and the upper conveying branch, and a lowering branch between the upper conveying branch and the lower return branch,
wherein the pallets are crosswise to a feed direction of the conveyor unit and move one after another along the feed direction of the conveyor unit,
wherein shaped rods, extending from opposite sides of the pallets, are configured to connect to one or more drive units external to the thermally insulated structure,
wherein the shaped rods pass through slits in the thermally insulated structure,
wherein at least one of the one or more drive units comprises a drive element wound in an endless loop, driven by a servomotor, and selectively connected to the pallets along the upper conveying branch and the lower return branch,
wherein the raising branch comprises an ascent elevator at a first end of the heating area of the furnace, and
wherein the lowering branch comprises a descent elevator at a second end of the heating area of the furnace.

18. The furnace of claim 17, wherein the slits comprise labyrinth slits.

19. A furnace for heat treatments of glass containers, the furnace comprising:
a thermally insulated structure; and
a conveyor unit of the thermally insulated structure;
wherein the conveyor unit comprises pallets configured to feed the glass containers forward in sequence to a loading area of the furnace, a heating area of the furnace, a cooling area of the furnace, and an unloading area of the furnace,
wherein the conveyor unit defines a flow path of the pallets along an upper conveying branch, a lowering branch, a lower return branch, and a raising branch,
wherein shaped rods, extending from opposite sides of the pallets, are configured to connect to one or more drive units external to the thermally insulated structure,
wherein the shaped rods pass through slits in the thermally insulated structure,
wherein at least one of the one or more drive units comprises a drive element selectively connected to the pallets along the flow path of the pallets,
wherein the raising branch comprises an ascent elevator at a first end of the heating area of the furnace, and
wherein the lowering branch comprises a descent elevator at a second end of the heating area of the furnace.

20. The furnace of claim 19, wherein the slits comprise labyrinth slits.
